(19) United States
(12) Patent Application Publication
(10) Pub. No.: US 2025/0125537 A1
(43) Pub. Date: Apr. 17, 2025

(54) ARRAY ANTENNA FORMED BY SUBARRAY ANTENNAS

(71) Applicant: Telefonaktiebolaget LM Ericsson (publ), Stockholm (SE)

(72) Inventors: Ola Tageman, Göteborg (SE); Benny Gustafson, Spånga (SE); Kim Nordqvist, Västra Frölunda (SE); Ingmar Andersson, Lindome (SE); Anders Martinsson, Göteborg (SE); Agneta Ljungbro, Bjärred (SE)

(21) Appl. No.: 18/834,469

(22) PCT Filed: Jan. 31, 2022
(86) PCT No.: PCT/SE2022/050095

§ 371 Date: Jul. 30, 2024

(51) Int. Cl. H01Q 21/06; H01Q 1/48; H01Q 21/00

(52) U.S. Cl. CPC H01Q 21/061; H01Q 1/48; H01Q 21/0087

(57) ABSTRACT

The present disclosure relates to an array antenna comprising at least two subarray antennas, each subarray antenna comprising at least one antenna element, an electrically conducting top ground plane, surrounding the antenna elements, and edges. Each subarray antenna is mounted adjacent at least one other subarray antenna such that at least one pair of adjacent subarray antennas is formed. For each subarray antenna, at least one edge is facing an edge of an adjacent subarray antenna, where a corresponding gap is formed between edges facing each other. The array antenna comprises a plurality of electrically conducting bridge parts, where the bridge parts are attached to, and electrically connecting, the top ground planes of each pair of adjacent subarray antennas, the bridge parts crossing the gaps.

### TECHNICAL FIELD

The present disclosure relates to an array antenna comprising subarray antennas mounted adjacent each other. Each subarray antenna comprises an electrically conducting ground plane.

### BACKGROUND

There is a general demand for increased data capacity in the digital communication networks globally. Today many 5G networks use phased arrays, but there are also solutions for 4G. The trend is that the arrays are getting bigger and bigger with an increased number of antenna elements; for future 6G networks there are discussions about arrays with more than 1000 antenna elements. Due to lack of bandwidth there is also a desire to use higher and higher frequencies. 5G is already today using for example 28 GHz and 39 GHz, and 47 GHz and possibly higher bands are considered as well. For 6G, frequencies around and above 100 GHz are considered, and future networks will most probably require even higher frequencies.

Having a relatively large number of antenna elements, it is a challenge to fit all antenna elements and all signal routing in a single antenna board. It would require a very complex antenna board with many layers, dense routing and fine features which would lead to cost increase and reduced manufacturing yield. Furthermore, non-planarity of such a large antenna board make it difficult to make connection to a main printed circuit board (PCB), for example a so-called motherboard, by soldering, and mismatch in thermal expansion tend to give poor reliability. Typically, there are limitations in maximum size of high resolution boards, substrates and packages during manufacturing, which may lead to reduced yield. In this context, instead of an antenna board there can be a corresponding antenna module/package/substrate/block/component.

An attractive way to implement such a system is to use a single integration board with several smaller antenna modules formed by subarray antennas, for example a board with subarray antennas on one side and cooling on the opposite side, a backside. Integrated circuits can be placed in the antenna modules and/or on the backside of the integration board A modular system is attractive because it provides design flexibility and a scalable array antenna.

New versions can be made reusing the same building blocks and large production volume of building blocks gives low production cost. There is no need to use the same technology and materials for the antenna modules as for, as an example, the system integration board.

In other words, antenna elements are integrated into antenna modules that constitute subarray antennas that are combined to form one or more larger array antennas.

When designing a larger total array antenna using smaller subarray antennas, there will be discontinuities or gaps in the antenna ground that could cause major problems with the antenna performance.

In cases where there is a connection of ground between antenna modules, then the ground current makes a long detour. This requires careful design of the impedance across the gap, and gives limitation in performance, topologies and design freedom.

It is not possible to make antenna modules arbitrarily thin to minimize the length of the detour because the antenna cavity depth is dictated by the operation frequency and bandwidth of the antenna design. Furthermore, the solder joints between the antenna module and the motherboard are preferably made with a BGA (Ball Grid Array). The outermost ball row/column of the BGA requires a certain distance to the package edge. This distance adds to the total length of the detour for the current.

The gaps may incur further problems, for example:
They can scatter or re-radiate and disturb the radiation pattern.
They can create disturbed impedance matching of antenna elements and coupling between elements.
Resonances and propagation can occur in the gaps which can scatter and distribute RF power between antenna elements in an unpredictable manner.

Other problems are due to that the antenna elements also will excite the edge parts, and that there is no control of the grounding of the common antenna ground plane, and the related ground currents, between the subarray antennas.

U.S. Pat. No. 8,154,457 discloses single antenna element radiator packages that are combined, where galvanic contact in the gaps between adjacent modules is provided by conductive resilient clips arranged at edges of the radiator packages. These clips run through the radiator packages and contact a PCB to which the radiator packages are mounted. Here, there are no ground planes with gaps, and the clips present a cumbersome and unreliable arrangement, with longer ground paths, that does not solve the present problem. Furthermore, such clips will not fit at higher frequency, since there is a minimum size of such clips to have them rigid enough to allow insertion and get the spring action. The clips will also block a significant part of the top surface at higher frequency. There is an uncertainty in at what positions contact is made.

U.S. Pat. No. 8,816,929 discloses aligning two or more array packages to form a large-scale antenna array where vias connect ground plane layers in gaps between adjacent array packages. This is a difficult solution, since vias have to be placed in gaps, and edge plating is required. The assembly requires a non-standard process where it is hard to apply solder, and to control where the solder goes/stops. There is furthermore a strict tolerance requirement for gap width and component placement.

It is an object of the present disclosure to provide an enhanced ground connections between adjacent antenna modules that constitute subarray antennas that are combined to form one or larger array antennas.

### SUMMARY

The above object is obtained by means of an array antenna comprising at least two subarray antennas, where each subarray antenna comprises at least one antenna element, an electrically conducting top ground plane surrounding the antenna elements, and edges. Each subarray antenna is mounted adjacent at least one other subarray antenna such that at least one pair of adjacent subarray antennas is formed. For each subarray antenna, at least one edge is facing an edge of an adjacent subarray antenna, where a corresponding gap is formed between edges facing each other. The array antenna comprises a plurality of electrically conducting bridge parts, where the bridge parts are attached to, and electrically connecting, the top ground planes of each pair of adjacent subarray antennas, the bridge parts crossing the gaps.

In this manner it is possible to establish a reliable and efficient electrical contact between the top ground planes of different subarray antennas that together form an array antenna, thereby connecting the ground in different subarray antennas or subarray antenna modules.

According to some aspects, the bridge parts are in the form of electrically conducting strips or in the form of bond wires. When the bridge parts are in the form of electrically conducting strips, they can be made in a metallized non-conducting material, or are made completely in metal. This means that a large plurality of bridge parts can be easily produced in a cost-effective manner.

According to some aspects, each bridge part is attached to a top ground plane by means of solder or electrically conducting glue. This enables efficient mounting of the bridge parts in a pick-and-place manufacturing process.

According to some aspects, each subarray antenna is formed in a multi-layer structure. According to some further aspects, each multi-layer structure comprises at least two dielectric layers and at least one intermediate ground plane that is electrically connected to a corresponding top ground plane.

This means that each subarray antenna can comprise signal routing formed in at least one intermediate ground plane. In the case of two or more intermediate ground planes, signal routing can also be formed between the intermediate ground planes and other structures formed in metallizations between adjacent dielectric layers, or in the dielectric layers.

According to some aspects, at least one intermediate ground plane that is electrically connected to a corresponding top ground plane by means of corresponding via connections. This means that one or more intermediate ground planes can be electrically connected by means of the bridge parts.

According to some aspects, each subarray antenna is connected to a main printed circuit board (PCB) by means of connection members. In this manner, the subarray antennas can be mounted to the main PCB in a standardized and well-known manner.

According to some aspects, the array antenna comprises a filling compound that at least fills the gaps such that the bridge parts are supported by the non-conducting filling compound.

This provides a more rigid and durable array antenna, where the bridge parts can be mounted after the non-conducting filling compound has been applied.

This object is also achieved by means of methods that are associated with the above advantages.

### BRIEF DESCRIPTION OF THE DRAWINGS

The present disclosure will now be described more in detail with reference to the appended drawings, where:

FIG. 1 schematically shows a top view of a subarray antenna;

FIG. 2 schematically shows a top view of an array antenna;

FIG. 3 schematically shows a cut-open side view of the array antenna according to a first example, the cut being taken along a line A-A in FIG. 2;

FIG. 4 schematically shows an enlarged perspective view of a first example of a bridge part;

FIG. 5 schematically shows an enlarged perspective view of a second example of a bridge part;

FIG. 6 schematically shows a cut-open side view of the array antenna according to a second example, the cut being taken along a line A-A in FIG. 2; and

FIG. 7 shows a flowchart for methods according to the present disclosure.

### DETAILED DESCRIPTION

Aspects of the present disclosure will now be described more fully hereinafter with reference to the accompanying drawings. The different devices, systems, computer programs and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

With reference to FIG. 1-FIG. 3 that show a first example of the present disclosure, there is an array antenna 100 comprising at least two subarray antennas 101a, 101b, 101c, 101d, where each subarray antenna 101a, 101b, 101c, 101d comprises at least one antenna element 1a-4a, 1b-4b, 1c-4c, 1d-4d, an electrically conducting top ground plane 102a, 102b, 102c, 102d, surrounding the antenna elements 1a-4a, 1b-4b, 1c-4c, 1d-4d, and edges 105a 106a; 103b, 106b; 104c, 105c; 103d, 104d.

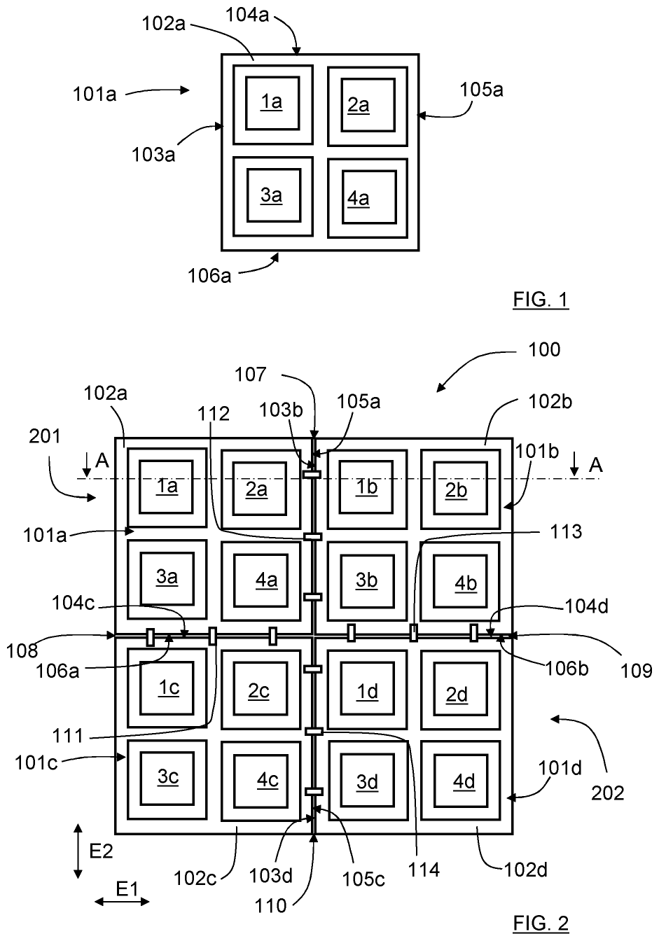

FIG. 1 shows a first subarray antenna 101a that has four antenna elements 1a-4a and an electrically conducting top ground plane 102a, surrounding the antenna elements 1a-4a, The array antenna 100 as shown in FIG. 2 comprises four subarray antennas 101a, 101b, 101c, 101d which in this example have the same configuration as the first subarray antennas 101a.

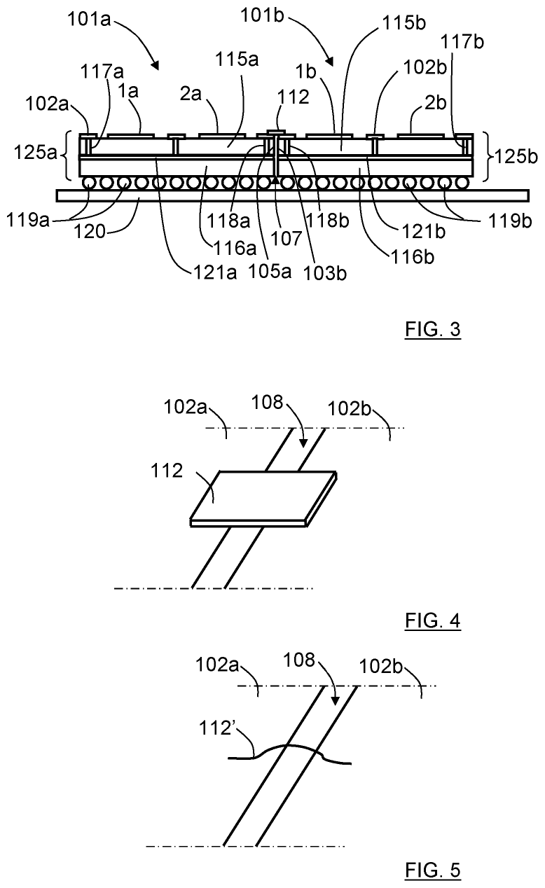

Each subarray antenna 101a, 101b, 101c, 101d is mounted adjacent at least one other subarray antenna 101a, 101b, 101c, 101d such that at least one pair 101a, 101b; 101a, 101c; 101b, 101d; 101c, 101d of adjacent subarray antennas is formed. As shown in FIG. 2 and FIG. 3, the first subarray antenna 101a is mounted adjacent a second subarray antenna 101b such that a first pair 101a, 101b of adjacent subarray antennas is formed. Furthermore, with reference to FIG. 2, the first subarray antenna 101a is also mounted adjacent a third subarray antenna 101c such that a second pair 101a, 101c of adjacent subarray antennas is formed. A fourth subarray antenna 101d is mounted adjacent the second subarray antenna 101b such that a third pair 101b, 101d of adjacent subarray antennas is formed, and the fourth subarray antenna 101d is also mounted adjacent the third subarray antenna 101c such that a fourth pair 101c, 101d of adjacent subarray antennas is formed.

For each subarray antenna 101a, 101b, 101c, 101d, at least one edge 105a, 106a; 103b, 106b; 104c, 105c; 103d, 104d is facing an edge 103b, 104c; 105a, 104d; 106a, 103d; 105c, 106b of an adjacent subarray antenna 101a, 101b, 101c, 101d, where a corresponding gap 107, 108, 109, 110 is formed between edges 104c, 106a; 105a, 103b; 106b, 104d; 105c, 103d facing each other. As shown in FIG. 1 and FIG. 2, the first subarray antenna 101a has a rectangular shape as seen towards the antenna elements 1a-4a and thus comprises four edges 103a, 104a, 105a, 106a, a first edge 103a, a second edge 104a, a third edge 105a and a fourth edge 106a.

As shown in FIG. 2 and FIG. 3, the third edge 105a of the first subarray antenna 101a is mounted adjacent a first edge 103b of the second subarray antenna 101b, such that a first gap 107 is formed. With reference to FIG. 2, the fourth edge 106a of the first subarray antenna 101a is mounted adjacent a second edge 104c of the third subarray antenna 101c, such that a second gap 108 is formed. A fourth edge 106b of the second subarray antenna 101b is mounted adjacent a second edge 104d of the fourth subarray antenna 101d, such that a third gap 109 is formed. A third edge 105c of the third subarray antenna 101c is mounted adjacent a first edge 103d of the fourth subarray antenna 101d, such that a fourth gap 110 is formed.

According to the present disclosure, as shown in FIG. 2 and FIG. 3, the array antenna 100 comprises a plurality of electrically conducting bridge parts 111, 112, 113, 114, where the bridge parts 111, 112, 113, 114 are attached to, and electrically connecting, the top ground planes 102a, 102b, 102c, 102d of each pair 101a, 101b; 101a, 101c; 101b, 101d; 101c, 101d of adjacent subarray antennas, the bridge parts 111, 112, 113, 114 (only one bridge part indicated with a reference number for each gap for reasons of clarity in FIG. 2) crossing the gaps 107, 108, 109, 110. As shown in FIG. 2, there are three bridge parts 111, 112, 113, 114 for each gap 107, 108, 109, 110, but there can of course be both more and less bridge parts for each gap.

In this manner it is possible to establish a reliable and efficient electrical contact between the top ground planes 102a, 102b, 102c, 102d of different subarray antennas 101a, 101b, 101c, 101d that together form an array antenna 100, thereby connecting the ground in different subarray antennas 101a, 101b, 101c, 101d or subarray antenna modules.

As in particular shown in FIG. 3, according to some aspects, each subarray antenna 101a, 101b, 101c, 101d is formed in a multi-layer structure 125a, 125b. Of course, a single-layer structure is also conceivable.

According to some aspects, each multi-layer structure 125a, 125b comprises at least two dielectric layers 115a, 116a; 115b, 116b and at least one intermediate ground plane 121a, 121b that is electrically connected to a corresponding top ground plane 102a, 102b, 102c, 102d. In FIG. 3, there are two dielectric layers 115a, 116a; 115b, 116b and one intermediate ground plane 121a, 121b for each subarray antenna 101a, 101b, 101c, 101d. In FIG. 3, only two subarray antennas 110a, 101b are shown, but of course all features described are applicable for all subarray antennas in the array antenna 100. This means that each subarray antenna 101a, 101b, 101c, 101d can comprise signal routing formed in at least one intermediate ground plane 121a, 121b. In the case of two or more intermediate ground planes, signal routing can also be formed between the intermediate ground planes and other structures formed in metallizations between adjacent dielectric layers, or in the dielectric layers.

In this example, for each subarray antenna 101a, 101b, 101c, 101d, there is a first dielectric layer 115a, 115b and a second dielectric layer 116a, 116b, where the dielectric layers 115a, 116a; 115b, 116b are separated by a corresponding intermediate ground plane 121a, 121b. There can of course be any suitable number of dielectric layers and intermediate ground planes, and this can differ between the subarray antennas.

According to some aspects, at least one intermediate ground plane 121a, 121b that is electrically connected to a corresponding top ground plane 102a, 102b, 102c, 102d by means of corresponding via connections 117a, 118a; 117b, 118b. This is illustrated in FIG. 3 and means that one or more intermediate ground planes can be electrically connected by means of the bridge parts 111, 112, 113, 114. Only some via connections are indicated for reasons of clarity, the number of via connections may of course vary.

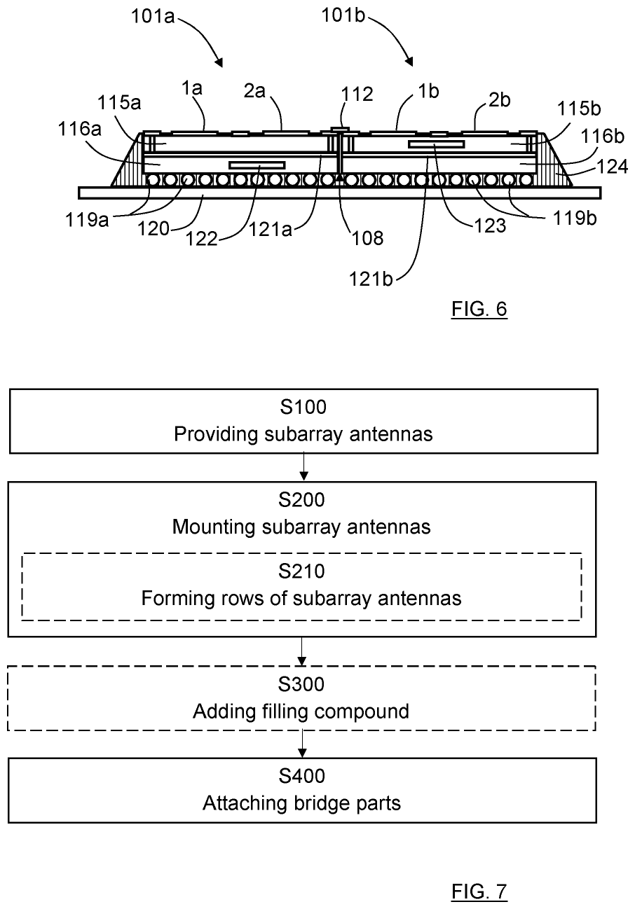

According to some aspects, as illustrated in FIG. 6, at least one dielectric layer 115a, 116a; 115b, 116b comprises electronic circuitry 122, 123. For example, the electronic circuitry can be an etched structure such as a coupler, a filter, etc. in an intermediate metallization that also comprises an intermediate ground plane, or it can be one or more embedded components such as capacitors, filters, frequency converters or amplifiers. In the example according to FIG. 6, there is a first piece of electronic circuitry 122 in the second dielectric layer 116a of the first subarray antenna 101a, and a second piece of electronic circuitry 123 in the first dielectric layer 115b of the second subarray antenna 101b. Said electronic circuitry 122, 123 can be connected to signal routing in any intermediate ground plane.

An intermediate metallization can be regarded as formed in an intermediate metallized layer, where an intermediate metallized layer that comprises signal routing and/or other etched structures also can be regarded as a signal layer.

According to some aspects, each subarray antenna 101a, 101b, 101c, 101d is connected to a main printed circuit board 120, PCB, by means of connection members 119a, 119b. This is illustrated in FIG. 3 and FIG. 6, here each subarray antenna 101a, 101b is connected to the main PCB 120 by means of a so-called ball-grid array (BGA). Many other types of connections are of course conceivable such as for example land grid array (LGA), hole-mounted leads and surface-mounted leads. In this manner, the subarray antennas can be mounted to the main PCB 120 in a standardized and well-known manner.

According to some aspects, the bridge parts 111, 112, 113, 114 are in the form of electrically conducting strips 112 or in the form of bond wires 112′.

According to some aspects, as illustrated in FIG. 4 that shows a first example of a bridge part, the bridge parts 111, 112, 113, 114 are in the form of electrically conducting strips 112 that either are made in a metallized non-conducting material, or are made completely in metal. As illustrated in FIG. 5 that shows a second example of a bridge part, the bridge parts are in the form of bond wires 112′. The bridge parts 111, 112, 113, 114 can according to some aspects be constituted by metal plated components. Different bridge parts may be used for one and the same array antenna 101. This means that a large plurality of bridge parts can be easily produced in a cost-effective manner

According to some aspects, each bridge part 111, 112, 113, 114; 112′ is attached to a top ground plane 102a, 102b, 102c, 102d by means of solder or electrically conducting glue. This can for example be realized in a pick-and-place manufacturing process.

FIG. 6 that corresponds to FIG. 3 illustrates a second example of the present disclosure. As shown in FIG. 3, the bridge parts 111, 112, 113, 114 are not supported when they cross the gaps 107, 108, 109, 110. According to some aspects, the array antenna 100 comprises a filling compound 124 that at least fills the gaps 107, 108, 109, 110 such that the bridge parts 111, 112, 113, 114 are supported by the non-conducting filling compound 124. This provides a more rigid and durable array antenna, where the bridge parts 111, 112, 113, 114 can be mounted after the non-conducting filling compound 124 has been applied.

For all examples, the application of the bridge parts 111, 112, 113, 114 can be done by for example screen printing, dispensing or additive manufacturing methods such as 3D-printing etc. Many other alternatives are of course conceivable. The bridge parts 111, 112, 113, 114 may not always have be constituted by loose parts that are mounted, for example a bridge part may according to some aspects consist of dispensed, or screen printed, conducting material only.

With reference to FIG. 7, the present disclosure also relates to a method for assembling an array antenna 100, where the method comprises providing S100 at least two subarray antennas 101a, 101b, 101c, 101d, each subarray antenna 101a, 101b, 101c, 101d comprising:
at least one antenna element 1a-4a, 1b-4b, 1c-4c, 1d-4d,
an electrically conducting top ground plane 102a, 102b, 102c, 102d surrounding the antenna elements 1a-4a, 1b-4b, 1c-4c, 1d-4d, and
edges 105a 106a; 103b, 106b; 104c, 105c; 103d, 104d.

The method further composes mounting S200 at least one row 201, 202 of subarray antennas 101a, 101b, 101c, 101d by mounting subarray antennas 101a, 101b; 101c, 101d pair-wise adjacent each other along a first extension E1, where, for each subarray antenna 101a, 101b, 101c, 101d, at least one edge 105a, 106a; 103b, 106b; 104c, 105c; 103d, 104d is facing an edge 103b, 104c; 105a, 104d; 106a, 103d; 105c, 106b of an adjacent subarray antenna 101a, 101b, 101c, 101d, where a corresponding gap 107, 108, 109, 110 is formed along edges 104c, 106a; 105a, 103b; 106b, 104d; 105c, 103d facing each other. The method also comprises attaching S400 a plurality of electrically conducting bridge parts 111, 112, 113, 114 to the adjacent top ground planes 102a, 102b, 102c, 102d such that each gap 107, 108, 109, 110 between adjacent top ground planes 102a, 102b, 102c, 102d is crossed and these top ground planes 102a, 102b, 102c, 102d are electrically connected to each other.

According to some aspects, the mounting S200 comprises forming S210 a plurality of rows 201, 202 of subarray antennas 101a, 101b; 101c, 101d, the rows 201, 202 being separated along a second extension E2 that is perpendicular the first extension E1.

According to some aspects, the method further comprises forming each subarray antenna 101a, 101b, 101c, 101d in a multi-layer structure 125a, 125b.

According to some aspects, each multi-layer structure 125a, 125b comprises at least two dielectric layers 115a, 116a; 115b, 116b and at least one intermediate ground plane 121a, 121b that is electrically connected to a corresponding top ground plane 102a, 102b, 102c, 102d.

According to some aspects, the method comprises electrically connecting at least one intermediate ground plane 121a, 121b to a corresponding top ground plane 102a, 102b, 102c, 102d using corresponding via connections 117a, 118a; 117b, 118b.

According to some aspects, the method comprises providing electronic circuitry 122, 123 to at least one dielectric layer 115a, 116a; 115b, 116b.

According to some aspects, the method comprises connecting each subarray antenna 101a, 101b, 101c, 101d to a main printed circuit board 120, PCB, using connection members 119a, 119b.

According to some aspects, the method comprises adding S300 a filling compound 124 to the mounted subarray antennas 101a, 101b, 101c, 101d, such that the filling compound 124 at least fills the gaps 107, 108, 109, 110 and such that the bridge parts 111, 112, 113, 114 are supported by the non-conducting filling compound 124.

The present disclosure is not limited to the above, but may vary freely within the scope of the appended claims. For example, one or more ground planes can be in the form of a ground mesh or ground structure. The intermediate ground planes can be used for forming signal routing.

A ground plane does thus not have to be a large coherent metallization, and each ground plane is comprised in a metallization layer. Etched structures such as couplers and filters can be formed in an intermediate metallization layer together with an intermediate ground plane. The top ground plane 102a, 102b, 102c, 102d surrounds the antenna elements 1a-4a, 1b-4b, 1c-4c, 1d-4d, where the top ground plane 102a, 102b, 102c, 102d and the antenna elements 1a-4a, 1b-4b, 1c-4c, 1d-4d are formed in a top metallization layer.

The subarray antennas 101a, 101b, 101c, 101d have been described to have a rectangular shape, other shapes such as for example triangular or hexagonal are also conceivable. Different shapes may be combined, and the subarray antennas may comprise different numbers of antenna elements.

1. An array antenna comprising at least two subarray antennas, each subarray antenna comprising at least one antenna element, an electrically conducting top ground plane, surrounding the antenna elements, and edges, where each subarray antenna is mounted adjacent at least one other subarray antenna such that at least one pair of adjacent subarray antennas is formed, where, for each subarray antenna at least one edge is facing an edge of an adjacent subarray antenna, where a corresponding gap is formed between edges facing each other, wherein the array antenna comprises a plurality of electrically conducting bridge parts, where the bridge parts are attached to, and electrically connecting, the top ground planes of each pair of adjacent subarray antennas, the bridge parts crossing the gaps.

2. The array antenna according to claim 1, wherein the bridge parts are in the form of electrically conducting strips or in the form of bond wires.

3. The array antenna according to claim 1, wherein the bridge parts are in the form of electrically conducting strips that either are made in a metallized non-conducting material, or are made completely in metal.

4. The array antenna according to claim 1, wherein each bridge part is attached to a top ground plane by means of solder or electrically conducting glue.

5. The array antenna according to claim 1, wherein each subarray antenna is formed in a multi-layer structure.

6. The array antenna according to claim 5, wherein each multi-layer structure comprises at least two dielectric layers and at least one intermediate ground plane that is electrically connected to a corresponding top ground plane.

7. The array antenna according to claim 6, wherein at least one intermediate ground plane that is electrically connected to a corresponding top ground plane by means of corresponding via connections.

8. The array antenna according to claim 5, wherein at least one dielectric layer comprises electronic circuitry.

9. The array antenna according to claim 1, wherein each subarray antenna is connected to a main printed circuit board, PCB, by means of connection members.

10. The array antenna according to claim 1, wherein the array antenna comprises a filling compound that at least fills the gaps such that the bridge parts are supported by the non-conducting filling compound.

11. A method for assembling an array antenna, where the method comprises:
providing at least two subarray antennas, each subarray antenna comprising at least one antenna element, an electrically conducting top ground plane surrounding the antenna elements;
mounting at least one row of subarray antennas by mounting subarray antennas pair-wise adjacent each other along a first extension (E1), where, for each subarray antenna, at least one edge is facing an edge of an adjacent subarray antenna, where a corresponding gap is formed along edges facing each other; and
attaching a plurality of electrically conducting bridge parts to the adjacent top ground planes such that each gap between adjacent top ground planes is crossed and these top ground planes are electrically connected to each other.

12. The method according to claim 11, wherein the mounting comprises:
forming a plurality of rows of subarray antennas, the rows being separated along a second extension that is perpendicular the first extension (E1).

13. The method according to claim 11, further comprising forming each subarray antenna in a multi-layer structure.

14. The method according to claim 13, wherein each multi-layer structure comprises at least two dielectric layers and at least one intermediate ground plane that is electrically connected to a corresponding top ground plane.

15. The method according to claim 14, wherein the method comprises electrically connecting at least one intermediate ground plane to a corresponding top ground plane using corresponding via connections.

16. The method according to claim 13, wherein the method comprises providing electronic circuitry to at least one dielectric layer.

17. The method according to claim 11, wherein the method comprises connecting each subarray antenna to a main printed circuit board, PCB, using connection members.

18. The method according to claim 11, wherein the method comprises adding a filling compound to the mounted subarray antennas, such that the filling compound at least fills the gaps and such that the bridge parts are supported by the non-conducting filling compound.
